(19) United States
(12) Patent Application Publication
(10) Pub. No.: US 2025/0308761 A1
(43) Pub. Date: Oct. 2, 2025

(54) COIL COMPONENT

(71) Applicant: Taiyo Yuden Co., Ltd., Tokyo (JP)

(72) Inventors: Shinya AKIYAMA, Tokyo (JP); Akihisa MATSUDA, Tokyo (JP)

(21) Appl. No.: 19/092,154

(22) Filed: Mar. 27, 2025

(30) Foreign Application Priority Data
Mar. 28, 2024 (JP) 2024-053795

(51) Int. Cl. H01F 27/32; H01F 27/29

(52) U.S. Cl. CPC H01F 27/324; H01F 27/292

(57) ABSTRACT

A coil component includes a magnetic base body containing magnetic metal particles, and having a first surface and a second surface that are opposite each other, a third surface adjacent to both the first surface and the second surface, and a fourth surface adjacent to the first surface, the second surface, and the third surface, and having a first edge line portion defined by the third surface and the fourth surface; a conductor disposed inside or on a surface of the magnetic base body; an external electrode that overlaps the first surface of the magnetic base and is electrically connected to the conductor, the external electrode having a plating layer; and a first insulation part embedded in the magnetic base body and partially exposed at the first edge line portion, the first insulation part being arranged in a position closer to the first surface than the second surface.

### TECHNICAL FIELD

This invention relates to coil components.

### BACKGROUND ART

In recent years, miniaturization and performance improvement of digital electronic devices have been progressing rapidly, and the density of electronic circuits and power supply circuits has been increasing. Accordingly, the importance of high performance and high-density mounting of coil components that make up electronic circuits or power supply circuits is increasing.

In order to achieve miniaturization while maintaining the performance of coil components, there is a need to reduce the volumes of the external electrodes. For this reason, sputtering films are used for some of the external electrodes to reduce their thickness, and the number of surfaces on which an external electrode is formed is reduced from five to three, and then to only one.

Coil components using magnetic metal materials are known for their ability to maintain performance while also being compact. Since the magnetic saturation characteristics of magnetic metal materials are better than those of magnetic ferrite materials, coil components using magnetic metal materials are used in applications in which direct current is applied. Since the magnetic saturation characteristics of magnetic metal materials are better, such coil components using magnetic metal materials can be made smaller by reducing the volume ratio of the magnetic material.

On the other hand, magnetic metal materials have lower electrical resistance than those of magnetic ferrite materials. For this reason, when attempting to form an external electrode on the surface of a magnetic base body that contains magnetic metal particles by plating, there is a risk that the plating will spread into unintended areas. In order to stably form the plating in a desired location, the magnetic base body is subjected to an insulation treatment as necessary.

For example, Patent Document 1 discloses a technique in which surfaces of a main body excluding areas for which the external electrodes are formed are covered with an insulating layer, and the external electrodes are exposed only on mounting surfaces. According to the technique disclosed in Patent Document 1, the external electrodes are stably formed only at the desired positions.

### BACKGROUND DOCUMENT(S)

### Patent Document(s)

Patent Document 1: JP 2023-106296 A

However, in the technology of Patent Document 1, the insulating layer is necessarily thick in order to ensure insulation, so that, in comparison with coil components without such an insulating layer, the amount of the magnetic material is less by the thickness of the insulating layer, and the magnetic characteristics are low.

Accordingly, the present invention provides a technique to form plating of an external electrode in a desired location and to minimize the spread of the plating to unnecessary positions, while maintaining the performance of a coil component.

### SUMMARY OF THE INVENTION

According to one aspect of the present invention, there is provided a coil component including a magnetic base body containing magnetic metal particles, and having a first surface and a second surface that are opposite each other, a third surface adjacent to both the first surface and the second surface, and a fourth surface adjacent to the first surface, the second surface, and the third surface, and having at least one first edge line portion defined by the third surface and the fourth surface; a conductor disposed inside or on a surface of the magnetic base body; at least one external electrode that overlaps the first surface of the magnetic base and is electrically connected to the conductor, the external electrode having a plating layer; and a first insulation part embedded in the magnetic base body and partially exposed at the first edge line portion, the first insulation part being arranged in a position closer to the first surface than the second surface.

Multiple first insulation parts may be provided at intervals along a direction in which the first edge line portion extends.

The first edge line portion of the magnetic base body may be round chamfered.

The first insulation part may be a layer that intersects with the first edge line portion.

The magnetic base body may further have at least one second edge line portion defined by the first surface and at least one of the third surface and the fourth surface. The second edge line portion may have a curved surface. The first insulation part may abut on the curved surface of the second edge line portion or overlap the curved surface of the second edge line portion.

The external electrode may overlap at least one of the third surface and the fourth surface in addition to the first surface. The first insulation part may be in contact with the external electrode in at least one of the first edge line portion, the third surface, and the fourth surface.

The first insulation part may be distant from the conductor.

The magnetic base body may further have at least one second edge line portion defined by the first surface and at least one of the third surface and the fourth surface. The coil component may include a second insulation part embedded in the magnetic base body and partially exposed at the second edge line portion.

According to this disclosure, the plating of the external electrode can be formed in a desired location and the spread of the plating to unnecessary positions is minimized, while maintaining the performance of the coil component.

### BRIEF EXPLANATION OF THE DRAWINGS

FIG. 1 is a perspective view of a coil component according to an embodiment of the present invention.

FIG. 2 is a perspective view of the coil component shown in FIG. 1 viewed from the bottom side.

FIG. 3 is a cross-sectional view of the coil component shown in FIG. 1.

FIG. 4 is a plan view of the coil component shown in FIG. 1.

FIG. 5 is a flowchart showing an example of a manufacturing method of the coil component shown in FIG. 1.

FIG. 6 is a perspective view of a drum core-type coil component according to a modification of the embodiment of the present invention.

FIG. 7 is a cross-sectional view of the coil component shown in FIG. 6.

FIG. 8 is a perspective view of a coil component that has a greater number of external electrodes, according to another modification of the embodiment of the present invention.

FIG. 9 is a plan view of a coil component that has insulation parts of other shapes, according to another modification of the embodiment of the present invention.

FIG. 10 is a cross-sectional view of a coil component that has multiple layers of insulation parts, according to another modification of the embodiment of the present invention.

FIG. 11 is a cross-sectional view of a coil component that has round-chamfered edge line portions, according to another modification of the embodiment of the present invention.

FIG. 12 is a partial enlarged view of a rounded edge line portion of the coil component shown in FIG. 11.

FIG. 13 is a cross-sectional view of a coil component in which each insulation part is in contact with an external electrode, according to another modification of the embodiment of the present invention.

FIG. 14 is a perspective view of a coil component that has insulation parts that are exposed at the second edge line portions, in addition to insulation parts that are exposed at the first edge line portions, according to another modification of the embodiment of the present invention.

FIG. 15 is a perspective view of a coil component that has two-surface covering type external electrodes, according to another modification of the embodiment of the present invention.

FIG. 16 is a cross-sectional view of the coil component shown in FIG. 15.

### DESCRIPTION OF EMBODIMENT

With reference to the accompanying drawings, an embodiment of the present invention will be described hereinafter. The following embodiment is not intended to limit the present invention, and not all of features in the embodiment are essential for the present invention. The embodiment may be modified or changed as appropriate depending on specifications of the devices to which the present invention is applied and conditions (conditions of use, environment of use, etc.).

The technical scope of the present invention is defined by the accompanying claims and is not limited by the following individual embodiments. The accompanying drawings used for the following description may differ in scale and shape from the actual structure for easy understanding of the embodiments. In the drawings, the same reference symbols will be used for identifying the same or similar components.

### Embodiment of Coil Component

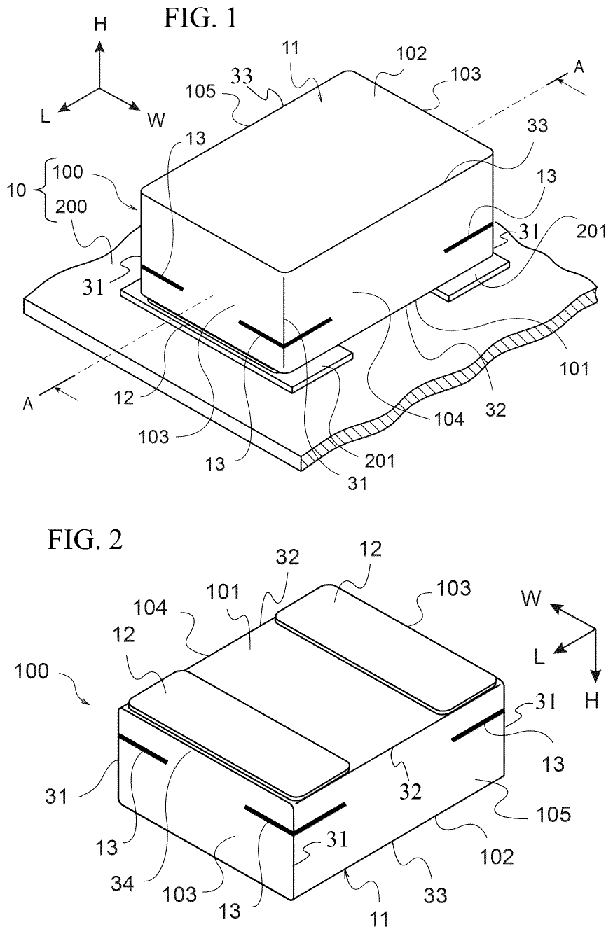

FIG. 1 is a perspective view of a coil component 100 according to an embodiment of the present invention.

The coil component 100 is mounted on a substrate 200. The substrate 200 has, for example, two land portions 201. The coil component 100 has, for example, two external electrodes 12. The coil component 100 is mounted on the substrate 200 by, for example, soldering the external electrodes 12 to the corresponding land portions 201, respectively.

A circuit board structure 10 includes the coil component 100 and the substrate 200 on which the coil component 100 is mounted. The circuit board structure 10 may be provided in various electronic devices including automotive electrical components, servers, single-board computers, and various other electronic devices.

In this disclosure, unless otherwise understood from context, directions are based on the L-axis, W-axis, and H-axis in FIG. 1, and are referred to as the length direction, width direction, and height direction, respectively.

The coil component 100 has a rectangular parallelepiped contour as an example. That is, the coil component 100 has an outer surface at each of the ends in the length direction L, the ends in the height direction H, and the ends in the width direction W.

The dimensions of each side of the rectangular parallelepiped coil component 100 are as follows:

The length is in the range of 1.0 to 4.5 mm, the width is in the range of 0.5 to 3.2 mm, and the height is in the range of 0.5 to 1.5 mm. The height is less than the length, and the height is less than the width.

The outer surfaces of the coil component 100 may be flat or curved. In addition, some of the eight vertices and twelve edge line portions of the coil component 100 may be rounded.

In this disclosure, even if some of the surfaces of the coil component 100 are curved or even if some of the vertices and the edge portions are rounded, the contour of the coil component 100 may be referred to as a “rectangular parallelepiped.” In other words, the term “rectangular parallelepiped” used herein does not necessarily mean a rectangular parallelepiped in the strict mathematical sense.

### Structure of Coil Component

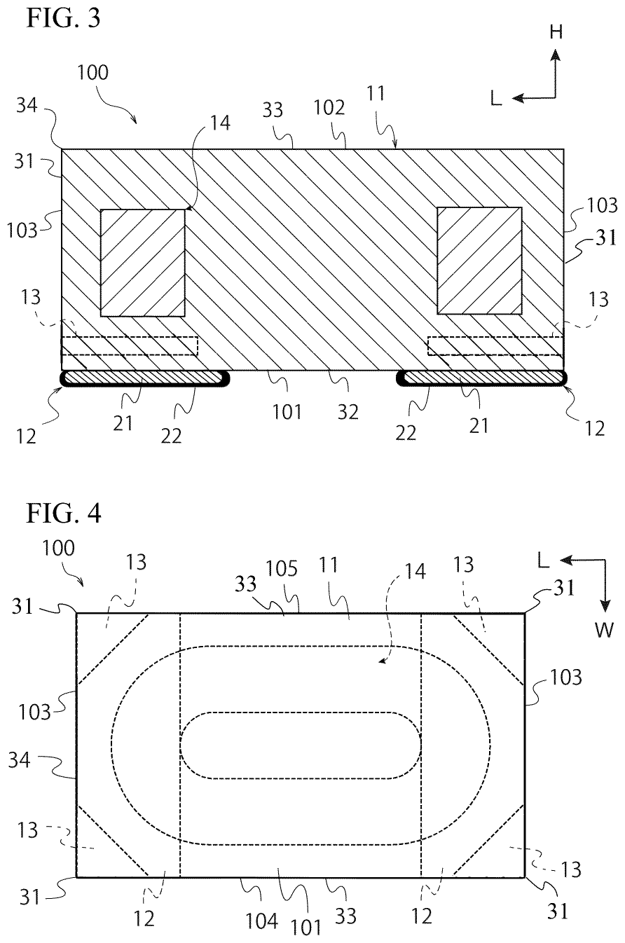

FIG. 2 is a perspective view of the coil component 100 shown in FIG. 1 viewed from the bottom side. FIG. 3 is a cross-sectional view of the coil component 100, and FIG. 4 is a plan view of the coil component 100. FIG. 3 shows a cross-section taken along line A-A in FIG. 1. The following description refers to FIGS. 1 to 4.

The coil component 100 has a magnetic base body 11, two external electrodes 12, four electric insulation parts 13, and an electric conductor 14 disposed inside the magnetic base body 11.

The magnetic base body 11 has a hexahedral (e.g., rectangular parallelepiped) shape as an example. In other words, the magnetic base body 11 has a bottom surface 101 at an end in the height direction H, and a top surface 102 at the other end in the height direction H. The magnetic base body 11 also has side surfaces 103 at both ends in the length direction L. Furthermore, the magnetic base body 11 has a front surface 104 at an end in the width direction W, and a rear surface 105 at the other end in the width direction W.

The bottom surface 101 corresponds to an example of a “first surface” in this disclosure, and the top surface 102 corresponds to an example of a “second surface” in this disclosure. One side surface 103 corresponds to an example of a “third surface” in this disclosure, and the front surface 104 corresponds to an example of a “fourth surface” in this disclosure. In addition, the other side surface 103 corresponds to an example of a “fifth side” in this disclosure, and the rear surface 105 corresponds to an example of a “sixth side” in this disclosure.

The top surface 102 is on the opposite to the bottom surface 101. The term “opposite” means that the surfaces are in orientations in which they are directed outward in opposite directions from each other. In addition, the top surface 102 is in a position adjacent to the side surfaces 103, the front surface 104, and the rear surface 105. The bottom surface 101 is also in a position adjacent to the side surface 103, the front surface 104, and the rear surface 105. The term “adjacent” means a positional relationship in which there is no other surface between the surfaces, and there is an edge line portion therebetween. In the example shown here, the adjacent surfaces are in a position in which they are orthogonal to each other.

The magnetic base body 11 has four edge line portions that extend along the height direction H, four edge line portions that surround the bottom surface 101, and four edge line portions that surround the top surface 102. The edge line portion defined by one side surface 103 and the front surface 104, the edge line portion defined by the other side surface 103 and the front surface 104, the edge line portion defined by one side surface 103 and the rear surface 105, and the edge line portion defined by other side surface 103 and the rear surface 105 are referred to as first edge line portions 31, which extend along the height direction H. The edge line portion defined by the bottom surface 101 and the front surface 104 along the length direction L and the edge line portion defined by the bottom surface 101 and the rear surface 105, which extend along the length direction L, are referred to as second edge line portions 32. The edge line portion defined by the top surface 102 and the front surface 104 along the length direction L and the edge line portion defined by the top surface 102 and the rear surface 105, which extend along the length direction L, are referred to as third edge line portions 33. The edge line portion defined by one side surface 103 and the bottom surface 101 and the edge line portion defined by the other side surface 103 and the bottom surface 101, which extend along the width direction W, are referred to as fourth edge line portions 34.

In this embodiment, the magnetic base body 11 is a magnetic body formed from particles of a magnetic metal material and a binder. The binder bonds the magnetic metal particles together, and is an insulating material with a high level of electric insulation to prevent electrical conduction. The binder is selected so that the magnetic base body 11 has a specific electrical resistance of 10⁶ Ωcm or higher. For example, a binding material with a specific electrical resistance of 10⁸ Ωcm or higher is selected as the material for the binder. In addition, to increase mechanical strength, a binding material such as a resin, glass, or a metal oxide may be selected for the binder. The binding material may be selected for the binder so that the surface resistance of the magnetic base body 11 is 10¹² Ω/sq. or higher.

In a case in which the magnetic metal material is mainly composed of Fe (iron), it is desirable to adjust the components and the blending ratio of the binder to be suitable for the electrical resistance of Fe since Fe has low electrical resistance. For example, a binder with a specific electrical resistance of 10⁸ Ωcm or higher is selected. To increase electrical insulation, the binder may contain a resin, and may also contain glass and/or a metal oxide added in the resin.

The magnetic base body 11 has an extremely high specific electrical resistance inside thereof. In addition, since the binder exists on the surfaces of the magnetic base body 11, the surfaces also have an extremely high specific electrical resistance. The particles of the magnetic metal material are particles of one or more of Fe, Ni (nickel), and Co (cobalt). In addition to magnetic metal particles, the magnetic metal material may also contain ceramic magnetic particles of one or more of Mg (magnesium), Mn (manganese), and Ni (nickel) and/or non-magnetic particles such as silica particles. The magnetic metal particles may also include particles of one or more of Si (silicon), Cr (chromium), Al (aluminum), B (boron), and P (phosphorus) in addition to Fe, Ni, and Co particles, or may be a combination of multiple types of magnetic metal particles.

The particles of the magnetic metal material have a particle size of 1 μm to 60 μm. If the magnetic metal material further includes other particles such as metal fine particles, metal oxide particles, ceramic particles, etc. in addition to the magnetic metal particles, the average particle diameter of the other particles is less than that of the particles of the magnetic metal material, and is, for example, 0.01 to 1 μm. The other particles may be used to reduce voids or compensate for mechanical strength rather than to enhance the magnetic quality.

In the magnetic base body 11, the filling rate of the magnetic metal material is from 80 vol % to 88 vol % and the remainder consists of non-magnetic metal materials that may include one or more insulators and/or voids.

The coil conductor 14 inside the magnetic base body 11 is made from a metallic material with excellent electrical conductivity. For example, one or more of Cu (copper), Al, Ni, or Ag (silver), or an alloy containing any of these metals can be used for the metallic material for the conductor 14. The conductor 14 may be a wound metal conductive wire having an insulating film on the peripheral surface thereof, or formed by plating or printing on the surface of one or more substrates, sheets, etc.

The coil conductor 14 in the embodiment has a loop section that has one or more turns. The loop section of the conductor 14 is shown in FIGS. 3 and 4. The number of turns of the loop section is, for example, from 1.5 to 10.5. The shape of the loop section may be flat or spiral. The loop section may, for example, be a single combination that has multiple turns in which an upper turn and a neighboring lower turn overlap with each other. FIGS. 3 and 4 illustrate a so-called horizontal loop section in which the conductive wire winds substantially in parallel to the bottom surface 101 and top surface 102 of the magnetic base body 11.

The conductor 14 has connection terminals or extensions (not shown) that are electrically connected to the outside. The connection terminals are connected to the external electrodes 12, respectively. Thus, the external electrodes 12 are electrically connected to the conductor 14. The production process of the conductor 14 may be any one of the processes of winding, thin film forming, or layering, and is not limited particularly.

The coil component 100 has two external electrodes 12 as an example. Each external electrode 12 shown in FIGS. 1 to 4 is a type of electrode called a one-surface covering type, and is provided on the bottom surface 101 of the magnetic base body 11, for example. Each external electrode 12 has a metal layer 21 having a thickness of 10 to 25 μm, and a plating layer 22 having a thickness of 2 to 15 μm that covers the metal layer 21. Each external electrode 12 may have multiple metal layers 21, and some of the metal layers 21 may include a resin in part. The total thickness of each external electrode 12 is 10 to 40 μm, for example. Each external electrode 12 may have a base layer or underlayer between the metal layer 21 and the magnetic base body 11.

Each external electrode 12 includes a layer of the same composition as that of the conductor 14, a layer of a composition having higher electrical resistance than that of the conductor 14, or both. The external electrode 12 also includes a layer having the same filling ratio as that in the conductor 14, a layer having a lower filling ratio than that in the conductor 14, or both.

Each metal layer 21 is formed from a metal material having an excellent electrical conductivity. As such a metal material, for example, Cu or Ag may be used, and as an alternative option, Ni, Pd (palladium), or Sn (tin) can be used. Each metal layer 21 may have multiple layers having different metal materials as the main components of the layers. An alloy may be formed in some of the multiple layers that make up each metal layer 21.

The plating layer 22 is provided to increase the strength of soldering to the corresponding external electrode 12. For example, the plating layer 22 includes two layers, i.e., an upper layer and a lower layer, such that the lower layer, which is in contact with the metal layer 21, contains, for example, Ni and the upper layer, which forms the outer surface of the external electrode 12, for example, contains Sn.

The edge line portions 31, 32, 33, and 34 of the magnetic base body 11 and the vicinities thereof tend to have lower electrical resistance and higher electric field strength than those in other parts. Therefore, when the plating layer 22 is formed on the bottom surface 101, the plating may extend along the first edge line portions 31 and/or the second edge line portions 32. In particular, if the plating extends along the first edge line portions 31, it may affect the neighboring electronic components on the substrate 200 and prevent high-density mounting.

Four electric insulation parts 13 are embedded in the magnetic base body 11. Two sides of each insulation part 13 are exposed on one of the side surfaces 103 and the front surface 104, so that part of the insulation part 13 is also exposed on the first edge line portion 31 between the side surface 103 and the front surface 104. Therefore, the insulation part 13 reduces the extension of the plating along the first edge line portion 31. The insulation part 13 is arranged in a position closer to the bottom surface 101, on which the external electrode 12 is provided, than the top surface 102 in the direction along the first edge line portion 31. In other words, the distance from the insulation part 13 to the bottom surface 101 is shorter than the distance from the insulation part 13 to the top surface 102. The insulation part 13 divides the first edge line portion 31 into a lower portion and an upper portion.

The insulation part 13 is flush with the outer surfaces of the magnetic base body 11 or recessed inwardly from the outer surfaces of the magnetic base body 11 in the vicinity of the first edge line portion 31 so as not to affect the external dimensions of the coil component 100.

Other insulation parts 13 that are exposed on the side surface 103 and rear surface 105, other insulation parts 13 that are exposed on the other side surface 103 and rear surface 105, and other insulation parts 13 that are exposed on the other side surface 103 and front surface 104 are also arranged in the same way as the above-mentioned insulation parts 13.

Each insulation part 13 forms a layer that intersects with the first edge line portion 31, which extends along the height direction H, as an example. Each insulation part 13 may form a continuous layer within the range indicated by the triangle in FIG. 4. Alternatively, each insulation part 13 may be divided into multiple parts within the range, or it may be formed as multiple spots within the range.

The layered insulation parts 13 can be easily created by a laminating process, and are desirable since they have small volumes occupied in the coil component 100. The insulation part 13 can stop the extension of the plating even if it is 5 μm or less in thickness.

The insulation parts 13 are preferably provided at positions distant from the conductor 14, i.e. positions that are different from areas through which the magnetic flux generated by the conductor 14 passes. As shown in FIG. 3, it is more preferable that the insulation parts 13 do not overlap the conductor 14 when viewed in the direction along the bottom surface 101. As shown in FIG. 4, it is further desirable that the insulation parts 13 be provided in positions that do not overlap the conductor 14 when viewed in a direction perpendicular to the bottom surface 101.

In a cross-section that is orthogonal to the first edge line portions 31 of the magnetic base body 11 (a cross-section that is parallel to the bottom surface 101 and top surface 102), the total area of the four insulation parts 13 is less than 10% of the area of the cross-section. The length of each insulation part 13 along the height direction H is less than 10% of the length of the first edge line portion 31. Consequently, the insulation parts 13 have a small magnetic effect on both the surface and inside of the magnetic base body 11, and do not cause a decrease in magnetic performance.

The specific resistance of each insulation part 13 is at least 10 times greater than the specific resistance of the magnetic base body 11. For example, if the specific resistance of the magnetic base body 11 is 10⁶ Ωcm, the specific resistance of each insulation part 13 is at least 10⁷ Ωcm. Furthermore, the specific resistance of each insulation part 13 may be 100 times or more than the specific resistance of the magnetic base body 11. As the specific resistance of each insulation part 13 is higher than that of the magnetic base body 11, the area in which each insulation part 13 is provided can be made small.

As described above, each insulation part 13 is formed from a material having a high specific resistance, and preferably, is formed from a non-magnetic material. Specifically, the material for each insulation part 13 is selected from a resin, glass, or a metal oxide. The material for each insulation part 13 is selected so as to be compatible with the binder of the magnetic base body 11.

The resin that is suitable for forming each insulation part 13 may be a thermosetting resin, such as a phenolic-type resin or an epoxy-type resin, having a glass transition point of 150 degrees Celsius or more. The glass that is suitable for forming each insulation part 13 may be a LTCC (Low temperature co-fired ceramics) material having a glass transition point of 750 degrees Celsius or less. The metal oxide that is suitable for forming each insulation part 13 may be particles of ceramics such as silica, alumina, or zirconia, or a composite material in which ceramic particles are bonded.

Each insulation part 13 may contain a magnetic material, but in this case, the magnetic material is not continuously exposed on the surface of the insulation part 13. For example, the volume ratio of the magnetic material in each insulation part 13 is 10 vol % or less.

Each insulation part 13 is formed of an insulating material that has the same components as those of the binder of the magnetic base body 11, or an insulating material that has at least one of strength and hardness that is higher than that of the binder. For example, in a case in which the binder of the magnetic base body 11 is a resin, the material of each insulation part 13 may be an oxide. For example, in a case in which the binder of the magnetic base body 11 is an oxide, the material of each insulation part 13 may be glass.

### Manufacturing Method for Coil Component

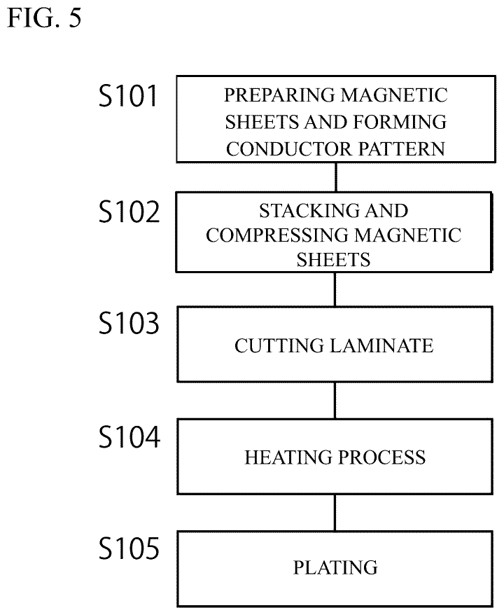

FIG. 5 is a flowchart showing an example of a manufacturing method for the coil component.

In step S101, multiple magnetic sheets made of composite magnetic materials containing the magnetic metal particles and the binder described above are prepared, and a flat conductor pattern for forming the conductor 14 is created on the surface of at least one of the magnetic sheets, for example, by printing. Other methods than printing may be used to create the conductor pattern, such as plating, vapor deposition, or paste transfer.

In addition, on the surface of a magnetic sheet, insulating layers having the shapes of the insulation parts 13 shown in FIG. 4 are formed by printing or transfer from an insulating paste containing glass material at the positions in which the insulation parts 13 are to be located.

In order to form the connection conductors that connect the conductor patterns that form the coil conductor 14 and the connection terminals that connect the conductor patterns to the external electrodes 12, through-holes are made in the multiple magnetic sheets, and the conductor material is filled in the through-holes. The through-holes are formed in locations other than the insulating layer. The connecting conductors and the connection terminals are formed by printing, filling, plating, vapor deposition, transfer, etc.

In step S102, the magnetic sheets are stacked, compressed, and integrated to obtain a laminate. The laminate corresponds to a composite of multiple coil components 100. On one surface of the laminate (corresponding to the bottom surface 101 of the multiple coil components 100), electrode patterns corresponding to the metal layers 21 of the external electrodes 12 for the multiple coil components 100 are formed by printing, plating, vapor deposition, transfer, etc.

In step S103, the laminate is cut and separated into individual laminated pieces corresponding to the individual coil components 100 are obtained. The insulating layers corresponding to the insulation parts 13 were formed in step S101 as patterns that span multiple coil components 100. In step S103, the laminate is cut, so that the two side surfaces 103, the front surface 104, and the rear surface 105 of each laminated piece are exposed as cut surfaces. In this way, the insulation parts 13 are also exposed.

In step S104, each laminated piece is subjected to a heating process and is cured. The heating process may vary depending on the raw materials used. For example, heat curing at a temperature of 200 degrees Celsius or less may be used, or sintering at a temperature of 600 degrees Celsius or more or 1100 degrees Celsius or more may be used.

In step S105, plating is applied to each of the cured pieces to form the plating layers 22 of the external electrodes 12. The plating films are formed on the electrode patterns corresponding to the metal layers 21. Accordingly, extension of the plating along the edge line portion of the laminated piece is reduced by the insulating layer (insulation part 13) exposed on the edge line portion of the laminated piece. As a result, the plating layers 22 are formed in desired locations while minimizing the spread to unnecessary portions. The plating in step S105 completes the coil component 100.

FIG. 5 shows a laminating method as an example of a manufacturing method for the coil components 100. However, the coil components 100 may also be manufactured using a powder compaction method, for example. In the powder compaction method for manufacturing the coil components 100, insulating members corresponding to the insulation parts 13 and conductor members corresponding to the conductors 14 are prepared. The insulating members and the conductor members are arranged at desired positions within a mold, and then, a slurry containing the magnetic metal material and the binder is filled into the mold. By unifying the insulating members and the conductor members in the slurry within the mold by applying pressure, a piece for the coil component 100 is obtained in which the magnetic material, insulating members, and conductor members are bonded.

The surfaces of the piece removed from the mold are, for example, polished to expose the end faces of the insulating members and the connecting terminals of the conductor members. After that, the external electrodes 12 are formed to complete the coil component 100. Also, in the case of the powder compaction method, when plating the external electrodes 12, the plating layers 22 are also formed in desired locations while minimizing the spread to unnecessary portions since each insulating member reduces the spread of the plating.

“The desired location” means the designed location for the plating layer 22 of the external electrode 12. For example, it is desirable that the platings are contained within the bottom surface 101 on which the external electrodes 12 are provided, or it is desirable that extensions of the platings from the bottom surface 101 are significantly small. In another design, it is desirable that the platings is contained within designed ranges in the bottom surface 101 on which the external electrodes 12 are provided, or it is desirable that extensions of the platings from the designed range are significantly small.

### Modifications

Modifications of the coil component will be described below. In the following, the same symbols are used for the same elements as those already described, and the description thereof is omitted.

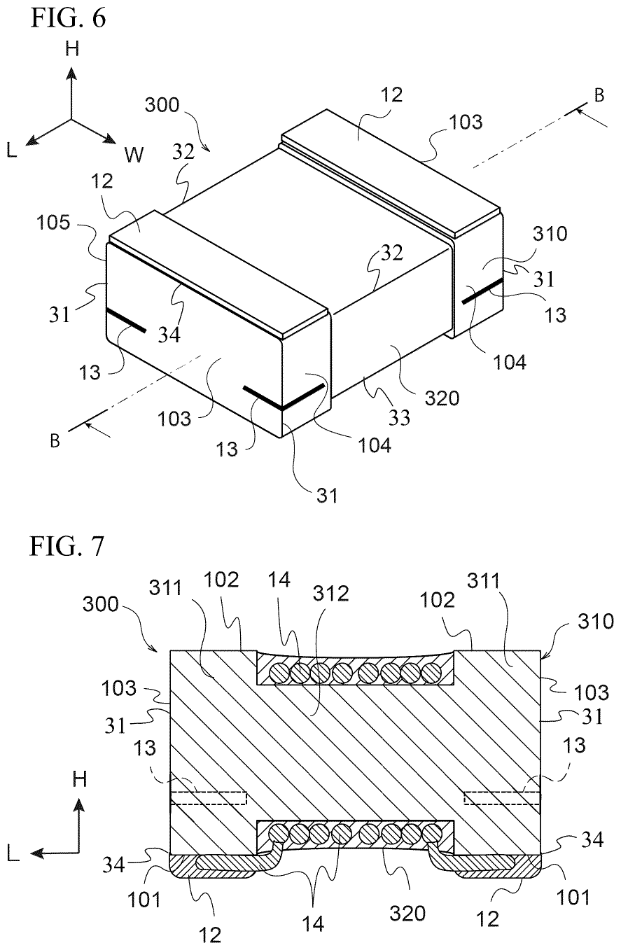

FIGS. 6 and 7 show a drum core-type coil component 300 according to a modification of the embodiment of the present invention. FIG. 6 is a perspective view of the coil component 300 viewed from the bottom side, and FIG. 7 is a cross-sectional view of the coil component 300 showing a cross-section taken along line B-B in FIG. 6.

The coil component 300 according to the modification has a drum core-type magnetic base body 310. The magnetic base body 310 has two flanges 311 and a core 312 that connects the flanges 311. The magnetic base body 310 has the bottom surface 101, the top surface 102, the side surfaces 103, the front surface 104, and the rear surface 105 on each flange 311, and also has the first edge line portion 31 on each flange 311.

In the coil component 300, the conductor 14 is wound around the outer circumference of the core 312. For example, the conductor 14 is a wire that is wound around the core 312. In the example shown in FIG. 7, the conductor 14 is wound vertically and is almost parallel to the two side surfaces 103.

The coil component 300 has, for example, a resin outer covering 320. The outer covering 320 covers the conductor 14 and protects it.

The four insulation parts 13 are embedded in the flanges 311 of the magnetic base body 310. Two sides of each insulation part 13 are exposed on the side surface 103 and the front surface 104 or the rear surface 105, so that part of each insulation part 13 is also exposed on the corresponding first edge line portion 31. Therefore, the insulation part 13 reduces the extension of the plating along the first edge line portion 31.

Also in the coil component 300, part of each insulation part 13 is exposed at the corresponding first edge line portion 31, so that the extension of the plating of the external electrode 12 is reduced, and the platings of the external electrodes 12 are formed in desired locations while minimizing the spread to unnecessary positions.

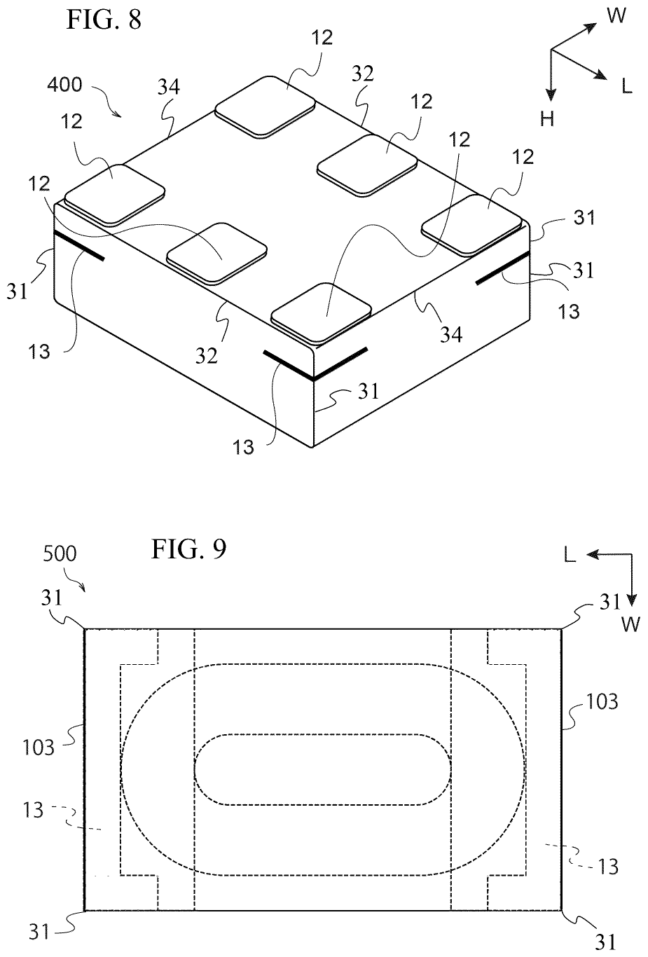

FIG. 8 shows a coil component 400 that has a greater number of external electrodes, according to another modification.

The coil component 400 has three pairs of external electrodes, i.e., six external electrodes. In the coil component 400 shown in FIG. 8, part of each insulation part 13 is also exposed at the corresponding first edge line portion 31, so that the extension of the plating of the external electrode 12 is reduced, and the platings of the external electrodes 12 are formed in desired locations while minimizing the spread to unnecessary positions.

FIG. 9 shows a coil component 500 that has insulation parts of other shapes than the above, according to another modification. FIG. 9 shows a plan view corresponding to FIG. 4.

The coil component 500 has two insulation parts 13. Each insulation part 13 extends along one of the side surfaces 103 and is exposed at the first edge line portion parts 31 at both ends of the side surface 103. Since the insulation parts 13 extend in this way, the insulation parts 13 are larger and have improved strength, and manufacturing of the coil component 500 is easier.

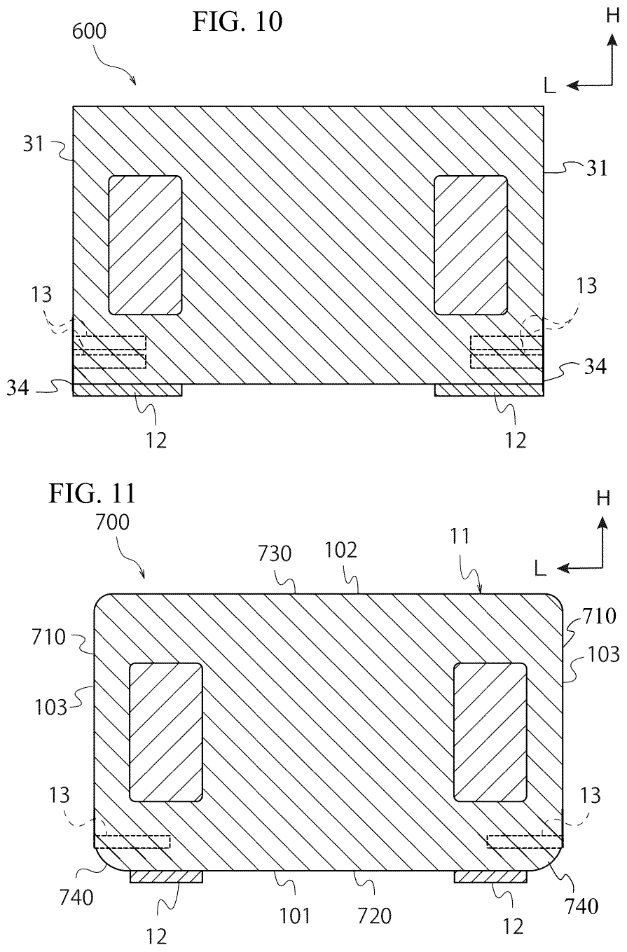

FIG. 10 shows a coil component 600 that has multiple layers of insulation parts, according to another modification. FIG. 10 shows a cross-sectional view corresponding to FIG. 3.

The coil component 600 has multiple layers of insulation parts 13 near each of the multiple first edge line portions 31. Each layer of the insulation part 13 intersects the first edge line portion 31 near the insulation part 13 and is exposed at the first edge line portion 31. The multiple layers of insulation parts 13 overlap in the direction along which the corresponding first edge line portion 31 extends, and are spaced apart from each other in the direction along which the corresponding first edge line portion 31 extends. Since each of the multiple layers of insulation parts 13 is exposed at the corresponding first edge line portion 31, the extension of the plating of the external electrode 12 is reliably stopped.

FIG. 11 shows a coil component 700 that has round-chamfered edge line portions, according to another modification.

In the coil component 700, all of the edge line portions of the magnetic base body 11 are round chamfered. That is, the magnetic base body 11 has four edge line portions that extend along the height direction H, four edge line portions that surround the bottom surface 101, and four edge line portions that surround the top surface 102. These edge line portions are round chamfered. However, the magnetic base body 11 may have some edge line portions that are not round chamfered.

The edge line portion defined by one side surface 103 and the front surface 104, the edge line portion defined by the other side surface 103 and the front surface 104, the edge line portion defined by one side surface 103 and the rear surface 105, and the edge line portion defined by other side surface 103 and the rear surface 105 are referred to as first edge line portions 710, which extend along the height direction H. The edge line portion defined by the bottom surface 101 and the front surface 104 along the length direction L and the edge line portion defined by the bottom surface 101 and the rear surface 105, which extend along the length direction L, are referred to as second edge line portions 720. The edge line portion defined by the top surface 102 and the front surface 104 along the length direction L and the edge line portion defined by the top surface 102 and the rear surface 105, which extend along the length direction L, are referred to as third edge line portions 730. The edge line portion defined by one side surface 103 and the bottom surface 101 and the edge line portion defined by the other side surface 103 and the bottom surface 101, which extend along the width direction W, are referred to as fourth edge line portions 740.

The radius of curvature of the curved surfaces at the edge line portions 710, 720, 730, and 740 is, for example, 20 μm or more and 100 μm or less. Since the curved surfaces are formed on the edge line portions 710, 720, 730, and 740, damage to the corners of the magnetic base 11 is reduced, and the extension of the plating due to the current concentration at the sharp edge line portion is reduced.

In the coil component 700 shown in FIG. 11, part of each insulation part 13 is exposed at the corresponding first edge line portion 710. Therefore, in combination with the fact that the curved surface is formed on the first edge line portion 710, the extension of the plating along the first edge line portion 710 is further reduced.

In the coil component 700 shown in FIG. 11, each insulation part 13 is arranged near the second edge line portion 720, which has a curved surface. In other words, each insulation part 13 is positioned closer to the bottom surface 101, on which the external electrode 12 is provided, than to the top surface 102, in the height direction H. As a result, it is possible to reduce the extensions of the platings of the external electrodes 12 beyond the second edge line portion 720 towards the first edge line portion 710.

Each insulation part 13 is exposed at an edge line portion that does not have a curved surface, as shown in FIGS. 1 to 4 and FIGS. 6 to 10, or is exposed at an edge line portion that has a curved surface, as shown in FIG. 11. In either case, each insulation part 13 is exposed at an edge line portion.

Next, the range of the edge line portion in FIG. 11 is explained.

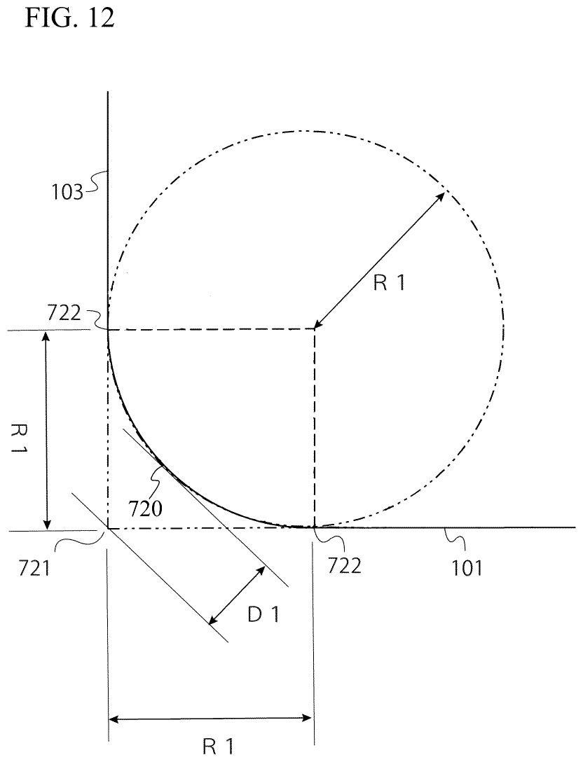

FIG. 12 shows an enlarged view of a rounded edge line portion of the coil component 700.

The coil component 700 has 12 rounded edge line portions. FIG. 12 shows the second edge line portion 720, but the other edge line portions 710, 730, and 740 have the same shape.

The range of the edge line portion 720 is a range corresponding to the curved surface having a curvature radius R1. The curvature radius R1 is calculated from the distance D1 between a real edge line portion 720 and a virtual edge line portion 721, which is the intersection of the extended plane of the bottom surface 101 and the extended plane of the side surface 103. That is, R1=(\sqrt{2}+1) D1. The two boundaries 722 of the range of the edge line portion 720 are located at positions that are away from the virtual edge line portion 721 by the curvature radius R1.

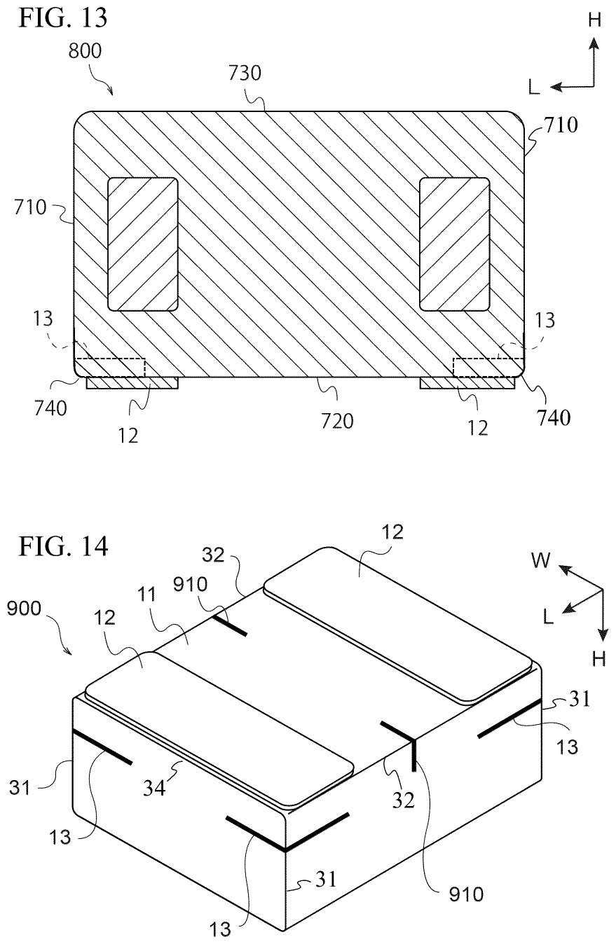

The insulation part 13 shown in FIG. 11 may abut on the upper boundary 722 of the second edge line portion 720. Alternatively, the insulation part 13 may overlap the boundary 722, as shown in FIG. 13. In any case, the insulation part 13 is located near the curved surface of the second edge line portion 720.

FIG. 13 shows a coil component 800, in which each insulation part is in contact with an external electrode, according to another modification.

The coil component 800 also has edge line portions 710, 720, 730, and 740 that have curved surfaces. Each insulation part 13 is located at the lower end of the corresponding first edge line portion 710 and is in contact with the external electrode 12. In other words, each insulation part 13 overlaps the second edge line portion 720, which has the curved surface.

Since each insulation part 13 is in contact with the external electrode 12, the extension of the plating of the external electrode 12 is further reduced.

FIG. 14 shows a coil component 900 that has insulation parts that are exposed at the second edge line portions in addition to the insulation parts that are exposed at the first edge line portions, according to another modification.

The coil component 900 has first insulation parts 13 that are exposed at the first edge line portions 31, in the same way as the coil component 100 shown in FIGS. 1 to 4. Furthermore, the coil component 900 has second insulation parts 910 that are exposed at the second edge line portions 32. The second insulation parts 910 are embedded in the magnetic base body 11, and part of each second insulation part 910 is exposed at the second edge line portion 32.

The insulation parts 910 reduce the extensions of the platings of the external electrodes 12 along the second edge line portions 32, and avoid a short circuit, i.e., an electrical connection between the two external electrodes 12.

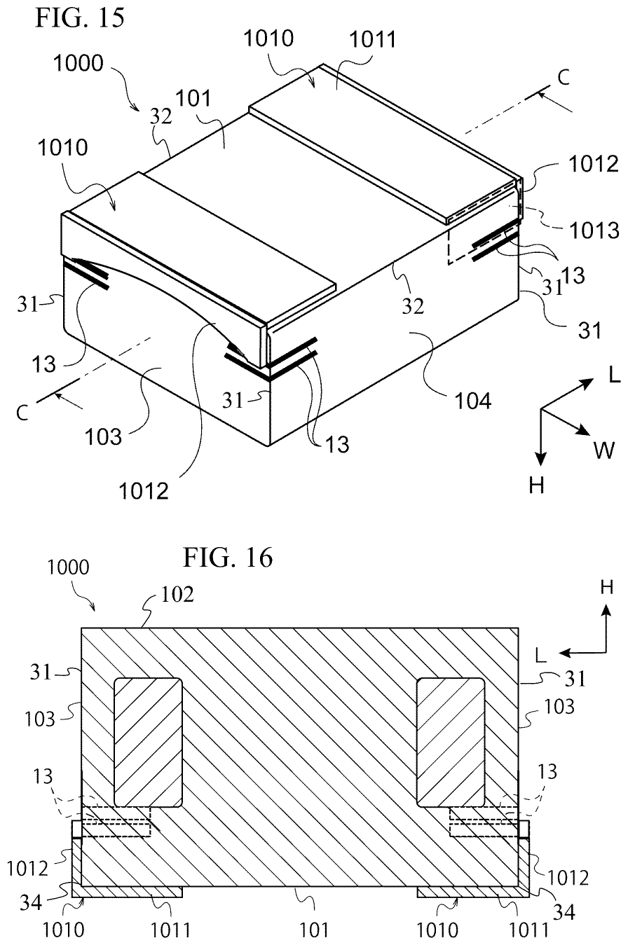

FIGS. 15 and 16 show a coil component 1000 that has two-surface covering type external electrodes, according to another modification. FIG. 15 is a perspective view of the coil component 1000 viewed from the bottom side, and FIG. 16 is a cross-sectional view of the coil component 1000 showing a cross-section taken along line C-C in FIG. 15.

The coil component 1000 has external electrodes 1010 of a type referred to as a two-surface covering type. That is, each external electrode 1010 is arranged on two surfaces, the bottom surface 101 and the side surface 103 of the magnetic base body 11. Each external electrode 1010 has a bottom overlapping portion 1011 that overlaps the bottom surface 101 and a side overlapping portion 1012 that overlaps the side surface 103.

Alternatively, each external electrode 1010 may be on three surfaces of the magnetic base body 11, i.e., the bottom surface 101, the side surface 103, and the front surface 104, and may have a bottom overlapping portion 1011 that overlaps the bottom surface 101, a side overlapping portion 1012 that overlaps the side surface 103, and a front overlapping portion 1013 that overlaps the front surface 104. Each insulation part 13 is in contact with at least one of the first edge line portions 31, the side surface 103, and the front surface 104, and is in contact with a part of the external electrode 1010.

The coil component 1000 has multiple layers of insulation parts 13 that are exposed at each first edge line portion 31. For each external electrode 1010 of the two-surface covering type having a side overlap portion 1012, it is more preferable to reduce the extension of the plating along the first edge line portion 31. The multiple layers of the insulation parts 13 more reliably reduce the extension of the plating.

In the coil component 1000, at least one of the multiple layers of insulation parts 13 that overlap each other along the first edge line portion 31 is located in contact with the external electrode 1010. The ends of the side overlap portions 1012 of each external electrode 1010 in the width direction W protrude toward the top surface 102. The lower insulation parts 13 are in contact with the ends of the side overlap portion 1012.

Since the lower insulation parts 13 are in contact with the external electrodes 1010, the extensions of the platings of the external electrodes 1010 are stopped near the external electrodes 1010. Accordingly, even in the side overlap portions 1012 that overlaps the side surfaces 103, the platings are formed in desired locations while the spread to unnecessary portions is minimized.

What is claimed is:

1. A coil component comprising:
a magnetic base body containing magnetic metal particles, and having a first surface and a second surface that are opposite each other, a third surface adjacent to both the first surface and the second surface, and a fourth surface adjacent to the first surface, the second surface, and the third surface, and having at least one first edge line portion defined by the third surface and the fourth surface;
a conductor disposed inside or on a surface of the magnetic base body;
at least one external electrode that overlaps the first surface of the magnetic base and is electrically connected to the conductor, the external electrode having a plating layer; and
a first insulation part embedded in the magnetic base body and partially exposed at the first edge line portion, the first insulation part being arranged in a position closer to the first surface than the second surface.

2. The coil component according to claim 1, comprising multiple first insulation parts provided at intervals along a direction in which the first edge line portion extends.

3. The coil component according to claim 1, wherein the first edge line portion of the magnetic base body is round chamfered.

4. The coil component according to claim 1, wherein the first insulation part is a layer that intersects with the first edge line portion.

5. The coil component according to claim 1, wherein the magnetic base body further has at least one second edge line portion defined by the first surface and at least one of the third surface and the fourth surface, the second edge line portion having a curved surface, wherein the first insulation part abutting on the curved surface of the second edge line portion or overlapping the curved surface of the second edge line portion.

6. The coil component according to claim 1, wherein the external electrode overlaps at least one of the third surface and the fourth surface in addition to the first surface, and wherein the first insulation part is in contact with the external electrode in at least one of the first edge line portion, the third surface, and the fourth surface.

7. The coil component according to claim 1, wherein the first insulation part is distant from the conductor.

8. The coil component according to claim 1, wherein the magnetic base body further has at least one second edge line portion defined by the first surface and at least one of the third surface and the fourth surface, and
wherein the coil component comprises a second insulation part embedded in the magnetic base body and partially exposed at the second edge line portion.
